(19) United States
(12) Patent Application Publication
(10) Pub. No.: US 2025/0278056 A1
(43) Pub. Date: Sep. 4, 2025

(54) IMAGE-FORMING APPARATUS INCLUDING DETACHABLE CHUTE CONFIGURED TO FORM PART OF RE-CONVEYING PATH POSITIONED BETWEEN SHEET TRAY AND DRAWER

(71) Applicant: BROTHER KOGYO KABUSHIKI KAISHA, Nagoya (JP)

(72) Inventor: Wataru YAMAGUCHI, Nisshin (JP)

(73) Assignee: BROTHER KOGYO KABUSHIKI KAISHA, Nagoya (JP)

(21) Appl. No.: 19/066,973

(22) Filed: Feb. 28, 2025

(30) Foreign Application Priority Data
Mar. 4, 2024 (JP) 2024-032539

(51) Int. Cl. G03G 21/16

(52) U.S. Cl. CPC G03G 21/1633; G03G 21/1685; G03G 2221/1639

(57) ABSTRACT

An image-forming apparatus includes a housing, a sheet supply tray, an image forming unit, a drawer, a re-conveying path, and a re-conveying chute. The housing includes: a first side wall having a first opening; and a second side wall positioned apart from the first side wall in a first direction. The image forming unit includes a cartridge. The drawer is configured to support the cartridge, and is movable in the first direction relative to the housing through the first opening. The drawer supports a registration roller. The re-conveying path is positioned upward of the sheet supply tray. The re-conveying chute is configured to form a part of the re-conveying path, the part of the re-conveying path being positioned between the sheet supply tray and the drawer in an up-down direction.

### REFERENCE TO RELATED APPLICATIONS

This application claims priority from Japanese Patent Application No. 2024-032539 filed on Mar. 4, 2024. The entire content of the priority application is incorporated herein by reference.

### BACKGROUND ART

Conventionally, there has been known an image-forming apparatus such as a color laser printer that includes an image-forming unit including a plurality of toner cartridges storing therein developing agents of different colors. The image-forming unit is configured to form an image onto a sheet by transferring the developing agents onto the sheet.

In recent years, in such an image-forming apparatus, there has been a demand to prolong the lifetime of the apparatus by configuring components of the apparatus into units so that the components can be replaced as a unit. For example, a prior art discloses an image-forming apparatus in which a plurality of toner cartridges is supported on a drawer that is attachable to and detachable from a housing of the image-forming apparatus, and each toner cartridge can be replaced with a new toner cartridge when the drawer is pulled out from the housing. Further, the drawer also supports a registration roller configured to correct orientation of a sheet to be conveyed to the image forming unit.

### SUMMARY

In a case where the drawer supporting the registration roller is configured to be attached to and detached from the housing as described above, positional accuracy of the drawer relative to the housing may be degraded, which may lower the sheet-orientation correcting function of the registration roller, compared to a structure where the drawer supporting the registration roller is fixed to the housing.

Particularly, in the above-identified image-forming apparatus, there is also provided a re-conveying path used for conveying a sheet (on whose front side an image is formed by the image-forming unit) to the image forming unit once again to form another image on a back side of the sheet. The re-conveying path is provided below a sheet tray supporting sheets to be supplied to the image forming unit. As the re-conveying path becomes longer in length, accuracy provided by the registration roller in performing the correction of the orientation of the sheet conveyed along the re-conveying path tends to be lowered.

It is therefore, an object of the present disclosure to provide an image-forming apparatus capable of maintaining a sheet-orientation correcting function of the registration roller even under a configuration where the drawer is made movable relative to the housing.

In order to attain the above and other objects, according to one aspect, the present disclosure provides an image-forming apparatus including a housing, a sheet supply tray, an image forming unit, a drawer, a re-conveying path, and a re-conveying chute. The housing includes: a first side wall having a first opening; and a second side wall positioned apart from the first side wall in a first direction. The sheet supply tray is configured to support a sheet thereon and is configured to be accommodated in the housing. The image forming unit includes a cartridge storing therein a developing agent. The image forming unit is configured to form an image on the sheet supplied from the sheet supply tray with the developing agent. The drawer is configured to support the cartridge. The drawer is movable relative to the housing in the first direction through the first opening. The drawer supports a registration roller configured to correct an orientation of the sheet. The sheet is configured to be conveyed along the re-conveying path toward the image forming unit after an image is formed on one side of the sheet by the image forming unit. The re-conveying path is positioned upward of the sheet supply tray in an up-down direction. The re-conveying chute is configured to form a part of the re-conveying path. The part of the re-conveying path is positioned between the sheet supply tray and the drawer in the up-down direction.

In a case where the drawer attached to the housing is movable in a direction from the first side wall toward the second side wall, accuracy in the attached position of the drawer relative to the housing may be degraded, compared to a case where the drawer is fixed to the housing. In a case where the positional accuracy of the drawer relative to the housing is lowered, the sheet-orientation correcting function of the registration roller provided on the drawer may be degraded. However, in the above-identified structure according to the one aspect of the disclosure, an entire length of the re-conveying path can be shortened since a part of the re-conveying path is arranged between the sheet supply tray and the drawer, which is in high contrast to a structure where the re-conveying path is positioned below the sheet supply tray. Accordingly, this configuration can maintain sheet-orientation correcting function of the registration roller with respect to the sheet conveyed along the re-conveying path.

According to another aspect, the present disclosure also provides an image-forming apparatus including a housing, a sheet supply tray, an image forming unit, a drawer, a re-conveying path, and a re-conveying chute. The housing includes: a first side wall having a first opening; and a second side wall positioned apart from the first side wall in a first direction. The sheet supply tray is configured to support a sheet and is configured to be accommodated in the housing. The image forming unit includes a cartridge storing therein a developing agent. The image forming unit is being configured to form an image on the sheet supplied from the sheet supply tray with the developing agent. The drawer is configured to support the cartridge. The drawer is movable relative to the housing in the first direction through the first opening. The sheet is configured to be conveyed along the re-conveying path toward the image forming unit after an image is formed on one side of the sheet by the image forming unit. The re-conveying path is positioned upward of the sheet supply tray in an up-down direction. The re-conveying chute is configured to form a part of the re-conveying path. The part of the re-conveying path is positioned between the sheet supply tray and the drawer in the up-down direction.

With this configuration, the drawer can be pulled out from the housing through the first opening without interference with the re-conveying chute.

### BRIEF DESCRIPTION OF DRAWINGS

FIG. 1 is a central cross-sectional view of an image-forming apparatus in a state where a front cover and a rear cover are respectively at closed positions thereof.

FIG. 2 is a central cross-sectional view of the image-forming apparatus in a state where the front cover and the rear cover are respectively at open positions thereof.

FIG. 3 is a perspective view of the image-forming apparatus as viewed from an upper-front side thereof in the state where both the front cover and the rear cover are respectively at the closed positions.

FIG. 4 is a perspective view of the image-forming apparatus as viewed from the upper-front side thereof in a state where the front cover is at the open position.

FIG. 5 is a perspective view of the image-forming apparatus as viewed from a rear side thereof in the state where both the front cover and the rear cover are respectively at the closed positions.

FIG. 6 is a perspective view of the image-forming apparatus as viewed from its rear side in a state where the rear cover is at the open position.

FIG. 7 is a perspective view of a fixing device as viewed from a front side thereof.

FIG. 8 is a perspective view of the fixing device as viewed from a rear side thereof.

FIG. 9 is a side view of the fixing device, and particularly illustrating a positional relationship among a fixing-device drive gear, a discharge-roller drive gear, and a fixing-device separation gear of the fixing device.

FIG. 10A is a cross-sectional side view of a mechanism for switching between a pressure contacting state and a separated state in the fixing device, and particularly illustrating the pressure contacting state of the fixing device.

FIG. 10B is a cross-sectional side view of the mechanism for switching between the pressure contacting state and the separated state in the fixing device, and particularly illustrating the separated state of the fixing device.

### DESCRIPTION

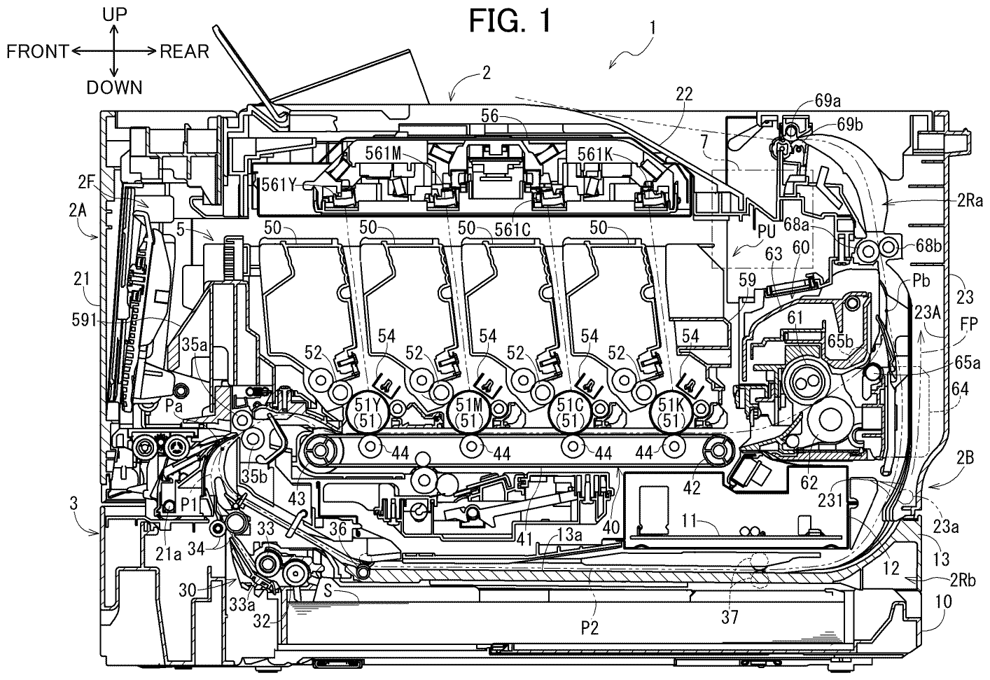

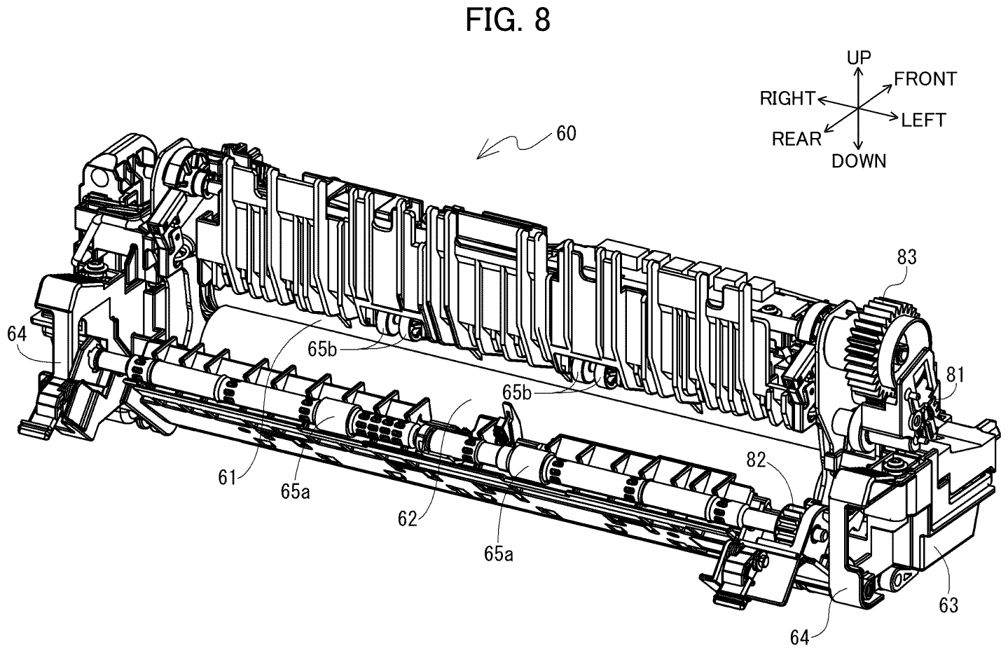

Hereinafter, one embodiment of the disclosure will be described with reference to FIGS. 1 through 10B.

### [Image-Forming Apparatus 1]

An image-forming apparatus 1 according to the one embodiment is illustrated in FIGS. 1 through 6. The image-forming apparatus 1 is an electrophotographic type color laser printer configured to form a multi-color image on a sheet S.

In the following description, the left side in FIG. 1 will be referred to as a front side of the image-forming apparatus 1, and the right side in FIG. 1 will be referred to as a rear side of the image-forming apparatus 1. Further, the near side in FIG. 1 will be referred to as a right side of the image-forming apparatus 1, and the far side in FIG. 1 will be referred to as a left side of the image-forming apparatus 1. Further, the upper side and lower side in FIG. 1 will be referred to as an upper side and a lower side of the image-forming apparatus 1, respectively.

The image-forming apparatus 1 includes a housing 2, a sheet supply unit 3, and an image forming unit 5. The sheet supply unit 3 includes a sheet tray 10 configured to support the sheet S, and a sheet conveying unit 30 configured to convey the sheet S. The image forming unit 5 is configured to form an image on the sheet S conveyed by the sheet supply unit 3. The housing 2 is an example of “housing” of the disclosure.

The housing 2 has a generally rectangular parallelepiped shape. The housing 2 accommodates therein the sheet supply unit 3 and the image forming unit 5. The housing 2 has a front surface 2A on which a front opening 2F is open. The housing 2 includes a front cover 21 configured to open and close the front opening 2F. The front surface 2A is an example of a “first side wall” of the disclosure. The front opening 2F is an example of a “first opening of the first side wall” of the disclosure.

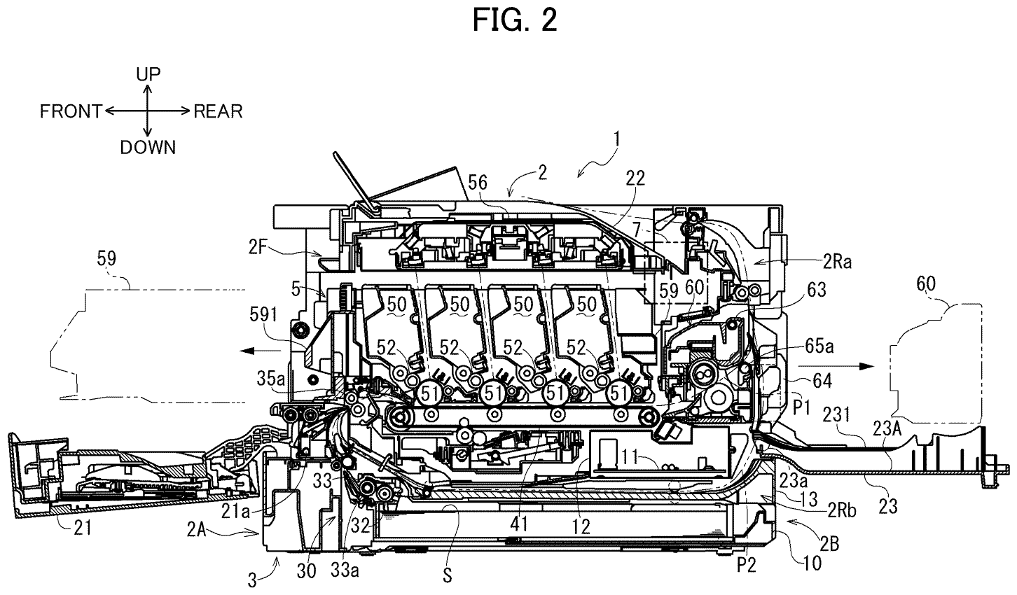

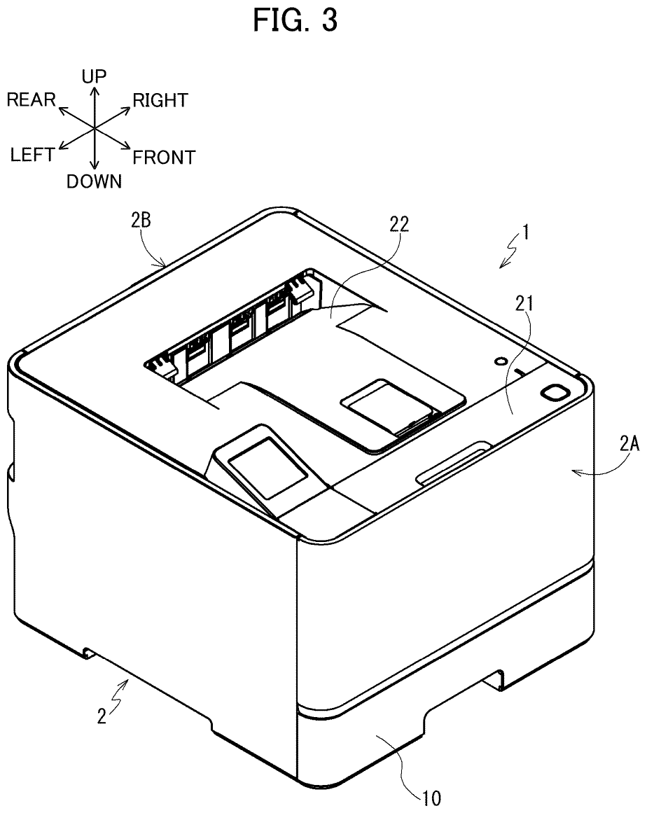

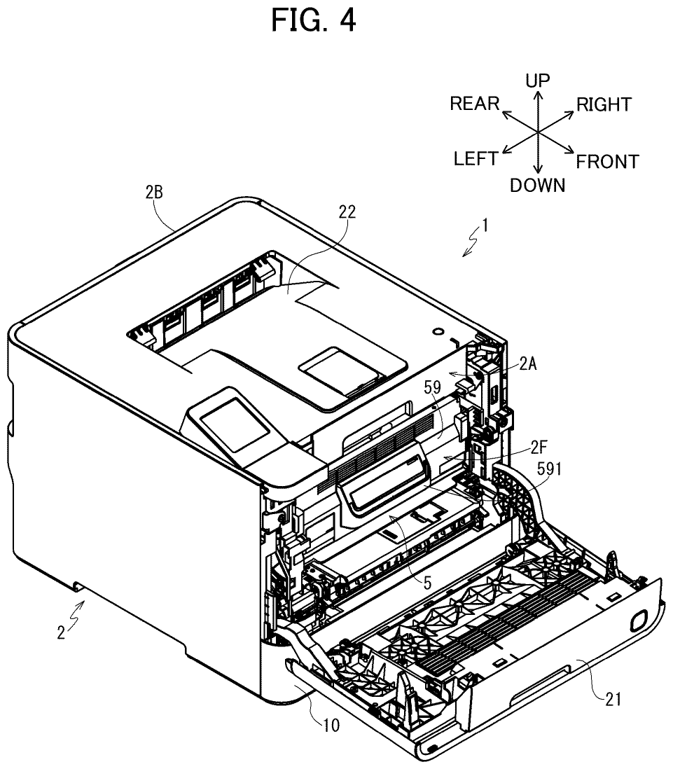

The front cover 21 has a lower end portion where a pivot shaft 21a is provided. The front cover 21 is pivotally movable about an axis of the pivot shaft 21a between a closed position (illustrated in FIGS. 1 and 3) where the front cover 21 closes the front opening 2F and an open position (illustrated in FIGS. 2 and 4) where the front cover 21 opens the front opening 2F. The housing 2 has an upper surface where a discharge tray 22 is formed. The discharge tray 22 is inclined diagonally downward toward the rear.

The housing 2 has a rear surface 2B. The rear surface 2B is positioned apart from the front surface 2A in a front-rear direction. A first rear opening 2Ra is open on the rear surface 2A. The housing 2 also includes a rear cover 23 configured to open and close the first rear opening 2Ra. The rear surface 2B is an example of “second side wall” of the disclosure. The first rear opening 2Ra is an example of “an opening of the second side wall” of the disclosure. The front-rear direction is an example of “first direction” of the disclosure.

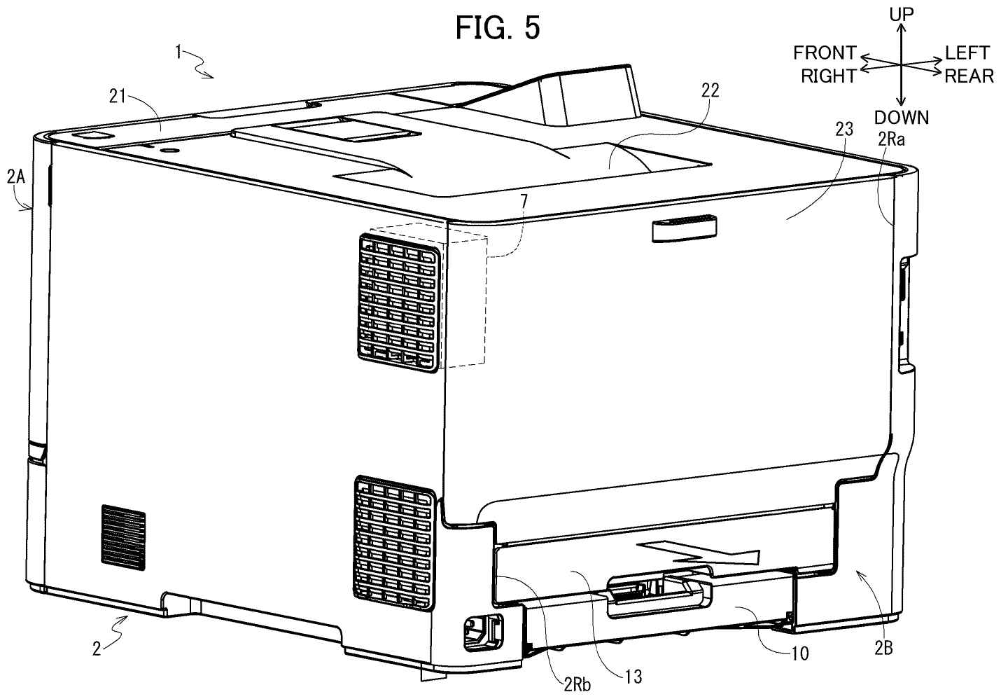

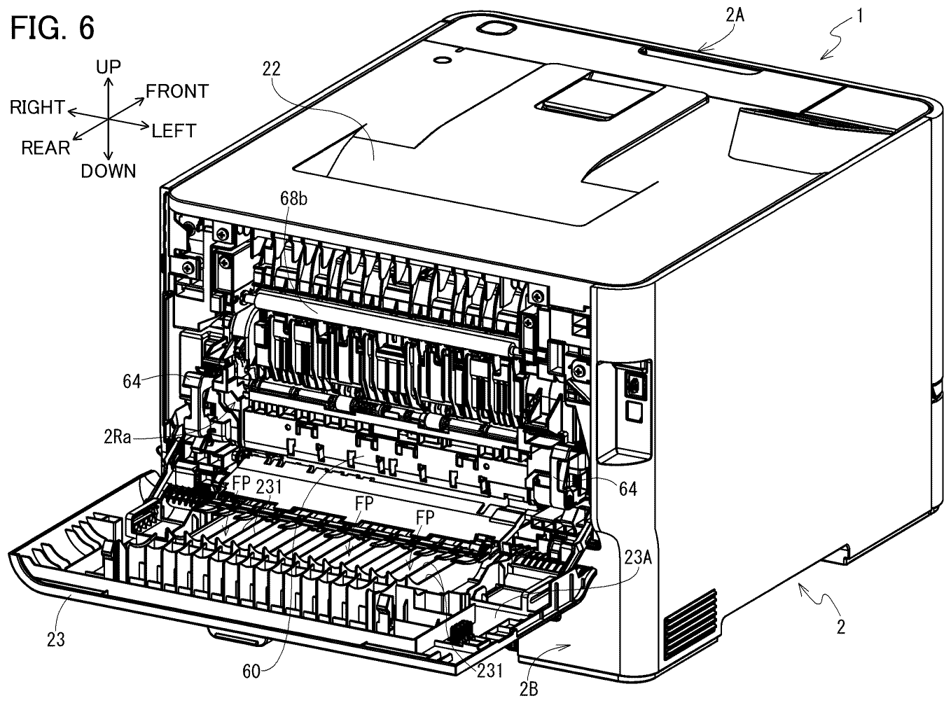

The rear cover 23 has a lower end portion where a pivot shaft 23a is provided. The rear cover 23 is pivotally movable about an axis of the pivot shaft 23a between a closed position (illustrated in FIGS. 1 and 5) where the rear cover 23 closes the first rear opening 2Ra and an open position (illustrated in FIGS. 2 and 6) where the rear cover 23 opens the first rear opening 2Ra. The rear cover 23 is an example of “cover” of the disclosure.

The sheet supply unit 3 is positioned in a lower region of the housing 2, and is configured to convey the sheet S supported by the sheet tray 10 to the image forming unit 5 by the sheet conveying unit 30. The sheet tray 10 supports a stack of the sheets S to be fed to the image forming unit 5. The sheet tray 10 is slidably movable in the front-rear direction (rearward and frontward) between an accommodated position where the sheet tray 10 is accommodated in the housing 2 and a separated position where the sheet tray 10 is pulled out frontward from the accommodated position.

The sheet conveying unit 30 includes a pick-up roller 32, a separation roller 33, a separation pad 33a, a pair of conveyer rollers 34, a registration roller 35a, and a follower roller 35b. The follower roller 35b is arranged to face the registration roller 35a. Within the housing 2, a conveying path P1 is defined. The conveying path P1 extends from the sheet tray 10 to the discharge tray 22 through the image forming unit 5.

The pick-up roller 32, the separation roller 33, and the separation pad 33a function to separate the sheets S supported on the sheet tray 10 one by one and convey the separated sheet S onto the conveying path P1. The pick-up roller 32 is configured to convey the sheet S from the sheet tray 10 toward the image forming unit 5. The separation roller 33 and the separation pad 33a constitute in combination a separator for separating each sheet S, one by one, from the remaining sheet(s) S supported on the sheet tray 10.

The sheet S delivered to the conveying path P1 is then conveyed toward the image forming unit 5 by the pair of conveyer rollers 34, the registration roller 35a, and the follower roller 35b.

The registration roller 35a and the follower roller 35b are configured to temporarily halts conveyance of the sheet S, by regulating movement of a leading edge of each sheet S conveyed toward the image forming unit 5 from the sheet tray 10, to correct an orientation of the sheet S, and then convey the sheet S toward the image forming unit 5 at a prescribed timing. The registration roller 35a is configured to correct the orientation of each sheet S supplied from the sheet tray 10 toward the image forming unit 5. The registration roller 35a is an example of “registration roller” of the disclosure. The registration roller 35a is also an example of “conveying roller” of the disclosure.

The image forming unit 5 is positioned above the sheet supply unit 3. The image forming unit 5 is an example of “image forming unit” of the disclosure.

The image forming unit 5 includes four toner cartridges 50 juxtaposed in the front-rear direction, and four photosensitive drums 51 corresponding to the respective toner cartridges 50. The four toner cartridges 50 (and the corresponding photosensitive drums 51) are provided respectively for the colors of yellow, magenta, cyan, and black.

The image-forming apparatus 1 also includes a drawer 59. The toner cartridges 50 are attachable to and detachable from the drawer 59. Further, the registration roller 35a is supported by the drawer 59.

The drawer 59 is attachable to and detachable from the housing 2. By opening the front cover 21, the drawer 59 can be attached to and detached from the housing 2 through the front opening 2F of the housing 2. The drawer 59 is an example of “drawer” of the disclosure.

The drawer 59 attached to the housing 2 is movable, through the front opening 2F, in a direction from the rear surface 2B toward the front surface 2A. That is, the drawer 59 attached to the housing 2 is movable frontward through the front opening 2F.

The drawer 59 has a front end portion where a handle 591 is provided. The handle 591 is used for moving the drawer 59. A user can move the drawer 59 attached to the housing 2 forward by gripping the handle 591 and pulls the handle 591 frontward.

In a state where the front cover 21 is at the open position, the drawer 59 can be pulled out of the housing 2 and detached therefrom by moving the drawer 59 attached to the housing 2 frontward through the front opening 2F. At this time, the front cover 21 having moved to its open position is displaced (offset) from a locus of the drawer 59 which is defined by movement of the drawer 59 in the front-rear direction so as to avoid mechanical interference between the front cover 21 and the drawer 59.

As such, in a process of moving the drawer 59 frontward through the front opening 2F, the movement of the drawer 59 is not disturbed by the front cover 21, and the drawer 59 can be smoothly pulled out of the housing 2. Further, in a process of moving the drawer 59 rearward through the front opening 2F, the rearward movement of the drawer 59 is not disturbed by the front cover 21, and the drawer 59 can be smoothly attached to the housing 2.

Each toner cartridge 50 is configured to store toner therein. Toner is an example of “developing agent” of the disclosure. Each toner cartridge 50 includes a developing roller 52. Each photosensitive drum 51 has a generally hollow cylindrical shape whose axis extends in a left-right direction as an axial direction. The photosensitive drums 51 are rotatably supported by the drawer 59. The developing roller 52 extends in the left-right direction, and is rotatably supported by a casing of the corresponding toner cartridge 50. The developing roller 52 is configured to supply toner to the corresponding photosensitive drum 51.

The four photosensitive drums 51 of the image forming unit 5 are arrayed in a sheet conveying direction (toward the rear in the embodiment). In the following description, the four photosensitive drums 51 arrayed in the sheet conveying direction will be respectively identified as follows, as appropriate: the photosensitive drum 51 positioned most upstream in the sheet conveying direction will be referred to as a first photosensitive drum 51Y corresponding to the color of yellow; the photosensitive drum 51 positioned downstream of the first photosensitive drum 51Y in the sheet conveying direction will be referred to as a second photosensitive drum 51M corresponding to the color of magenta; the photosensitive drum 51 positioned downstream of the second photosensitive drum 51M in the sheet conveying direction will be referred to as a third photosensitive drum 51C corresponding to the color of cyan; and the photosensitive drum 51 positioned downstream of the third photosensitive drum 51C in the sheet conveying direction will be referred to as a fourth photosensitive drum 51K corresponding to the color of black.

The housing 2 accommodates therein an exposing device 56 configured to expose peripheral surfaces of the respective photosensitive drums 51 to light. The exposing device 56 includes a laser diode, a light beam deflector, lenses, mirrors, and the like. The exposing device 56 is configured to irradiate a light beam toward each photosensitive drum 51 to expose the peripheral surface of each photosensitive drum 51 to light.

The exposing device 56 includes a first scanner 561Y configured to scan the peripheral surface of the first photosensitive drum 51Y with a light beam, a second scanner 561M configured to scan the peripheral surface of the second photosensitive drum 51M with a light beam, a third scanner 561C configured to scan the peripheral surface of the third photosensitive drum 51C with a light beam, and a fourth scanner 561K configured to scan the peripheral surface of the fourth photosensitive drum 51K with a light beam. As such, the exposing device 56 includes the four scanners 561Y, 561M, 561C and 561K corresponding to the photosensitive drums 51Y, 51M, 51C and 51K, respectively.

A transfer belt 41 is positioned below the four photosensitive drums 51 to face the same such that the conveying path P1 is defined between the transfer belt 41 and each photosensitive drum 51. The transfer belt 41 is in contact with each of the photosensitive drums 51. The transfer belt 41 is an endless belt mounted under tension over a drive roller 42 and a follow roller 43 positioned frontward of the drive roller 42. In an internal space defined by the transfer belt 41, four transfer rollers 44 are arranged such that each transfer roller 44 faces the corresponding photosensitive drum 51 with the transfer belt 41 nipped therebetween. The transfer belt 41, the drive roller 42, the follow roller 43, and the transfer rollers 44 in combination constitute a belt unit 40 (see FIG. 1) of the image forming unit 5.

The image forming unit 5 also includes chargers 54 configured to charge the peripheral surfaces of the respective photosensitive drums 51. The chargers 54 are supported by the drawer 59. The photosensitive drums 51 uniformly charged by the corresponding chargers 54 are selectively exposed to light by the corresponding exposing devices 56. By this exposure to light, electric charge is selectively removed from the peripheral surface of each photosensitive drum 51 and an electrostatic latent image is formed on the peripheral surface of each photosensitive drum 51.

The toner stored in each toner cartridge 50 is charged to have a positive polarity, and is carried on a peripheral surface of the corresponding developing roller 52. A developing bias is applied to each developing roller 52, so that the toner is supplied from each developing roller 52 to the electrostatic latent image formed on the corresponding photosensitive drum 51 due to the difference in electric potential between the electrostatic latent image and the developing roller 52 when the electrostatic latent image faces the corresponding developing roller 52. In this way, a toner image is formed on the peripheral surface of each photosensitive drum 51.

Once the sheet S conveyed toward the image forming unit 5 reaches the transfer belt 41, the sheet S sequentially passes through positions defined between each photosensitive drum 51 and the transfer belt 41 while the sheet S is being conveyed by the transfer belt 41. The toner images carried on the peripheral surface of each photosensitive drum 51 is transferred to the sheet S by a transfer bias applied to each transfer roller 44 when each toner image faces the sheet S. In this way, the image forming unit 5 forms an image on the sheet S supplied from the sheet tray 10 by transferring the toner to the sheet S.

Incidentally, the transfer belt 41 according to the present embodiment is in a form of a conveyer belt configured to convey a sheet S to which a toner image is to be transferred. However, a transfer belt of the disclosure may be in a form of an intermediate transfer belt to which a toner image is to be transferred, and the transferred toner image on the belt is then transferred on a supplied sheet S.

After the toner image is transferred to the sheet S, the sheet S is then conveyed to a fixing device 60. The fixing device 60 includes a heat roller 61, and a pressure roller 62 in pressure contact with the heat roller 61. The heat roller 61 and the pressure roller 62 are arranged such that axes thereof are aligned in the left-right direction. That is, the left-right direction is coincident with an axial direction of each of the heat roller 61 and the pressure roller 62. The fixing device 60 is an example of “fixing device” of the disclosure. The heat roller 61 is an example of “rotatable heating body” of the disclosure, and the pressure roller 62 is an example of “rotatable pressing body” of the disclosure.

In the fixing device 60, the toner image is thermally fixed to the sheet S while the sheet S passes through a position between the heat roller 61 and the pressure roller 62. That is, the fixing device 60 is configured to thermally fix the toner image to the sheet S. The fixing device 60 is attachable to and detachable from the housing 2.

The fixing device 60 further includes a fixing-device discharge roller 65a and a counter roller 65b. The fixing-device discharge roller 65a and the counter roller 65b are positioned downstream relative to the heat roller 61 and pressure roller 62 in the sheet conveying direction. The counter roller 65b is arranged to face the fixing-device discharge roller 65a. The fixing-device discharge roller 65a is an example of “discharge roller” of the disclosure. The

The sheet S to which the toner image has been thermally fixed is conveyed, by the fixing-device discharge roller 65a and the counter roller 65b, toward further downstream in the sheet conveying direction from the heat roller 61 and the pressure roller 62.

An intermediate discharge roller 68a and a follower roller 68b facing the intermediate discharge roller 68a are positioned downstream relative to the fixing-device discharge roller 65a and the counter roller 65b in the sheet conveying direction. Further, a discharge roller 69a and a follower roller 69b facing the discharge roller 69a are positioned downstream of the intermediate discharge roller 68a and the follower roller 68b in the sheet conveying direction.

The sheet S, which has been conveyed downstream in the sheet conveying direction relative to the fixing-device discharge roller 65a and the counter roller 65b, is conveyed by the intermediate discharge roller 68a and the follower roller 68b, and is then conveyed by the discharge roller 69a and the follower roller 69b to be discharged onto the discharge tray 22.

In the image-forming apparatus 1, the drawer 59, the toner cartridges 50 supported by the drawer 59, the photosensitive drums 51, the chargers 54, and like constitute in combination a process unit PU (see FIG. 1) configured to form a toner image on each sheet S. Incidentally, the process unit PU may at least include the photosensitive drums 51 and the chargers 54, or may further include the transfer belt 41 or the fixing device 60.

The image-forming apparatus 1 also includes a power circuit board 11 forming a power-supply circuit, and a circuit board cover 12 covering the power circuit board 11. The circuit board cover 12 is formed by a sheet metal having an electrical conductivity, and is grounded. In an up-down direction, the circuit board cover 12 is positioned between the sheet tray 10 and the belt unit 40, and between the sheet tray 10 and the fixing device 60. The process unit PU and the circuit board cover 12 are accommodated in the housing 2.

Each of the discharge roller 69a and the intermediate discharge roller 68a is rotatable both in a normal direction in which the sheet S is conveyed toward the discharge tray 22 and in a reverse direction opposite to the normal direction.

A re-conveying path P2 is also provided in the housing 2. The re-conveying path P2 is configured to guide the sheet S, which was conveyed along the conveying path P1 and moved past the fixing device 60, to a position on the conveying path P1, the position being upstream relative to the registration roller 35a in the sheet conveying direction. The re-conveying path P2 is configured to guide the sheet S on whose one side an image was formed by the image forming unit 5 toward the image forming unit 5 again for forming an image on the other side of the sheet S.

The re-conveying path P2 is branched from the conveying path P1 at a bifurcation point Pb, then extends frontward between the circuit board cover 12 and the sheet tray 10, and is then converged with the conveying path P1 at a merging point Pa. The bifurcation point Pb is a position located between the fixing-device discharge roller 65a and the intermediate discharge roller 68a. The merging point Pa is a position located between the registration roller 35a and the pair of conveyer rollers 34. That is, the re-conveying path P2 extends from the bifurcation point Pb to the merging point Pa. The re-conveying path P2 is positioned above the sheet tray 10 in the up-down direction.

The sheet S conveyed from the fixing device 60 to the discharge roller 69a can be conveyed again to the image forming unit 5 along the re-conveying path P2 by the reverse rotations of the discharge roller 69a and the intermediate discharge roller 68a.

The sheet S conveyed along the re-conveying path P2 by the discharge roller 69a and the intermediate discharge roller 68a is then conveyed toward the image forming unit 5 by a first re-conveying roller pair 36 and a second re-conveying roller pair 37 both of which are positioned at the re-conveying path P2.

The image-forming apparatus 1 further includes a re-conveying chute 13. The re-conveying chute 13 is positioned between the sheet tray 10 and the circuit board cover 12 in the up-down direction inside the housing 2, thereby defining a part of the re-conveying path P2 positioned between the sheet tray 10 and the circuit board cover 12 in the housing 2. The re-conveying chute 13 is an example of “re-conveying chute” of the disclosure.

The re-conveying chute 13 is positioned below the part of the re-conveying path P2 positioned between the sheet tray 10 and the circuit board cover 12 in the housing 2. The re-conveying chute 13 has a guide surface 13a configured to guide a lower surface of the sheet S conveyed along the part of the re-conveying path P2.

With the structure described above, the image-forming apparatus 1 can perform printing on both sides of the sheet S, by conveying the sheet S again to the image forming unit 5 along the re-conveying path P2 to form an image on the other side of the conveyed sheet S after an image was formed on one side of the sheet S by the image forming unit 5.

### [Position of the Re-Conveying Path P2 in the Up-Down Direction]

The part of the re-conveying path P2 defined by the re-conveying chute 13 is positioned between the sheet tray 10 and the drawer 59 in the up-down direction in the housing 2. That is, in the housing 2, the part of the re-conveying path P2 defined by the re-conveying chute 13 is positioned above the sheet tray 10; and the drawer 59 is positioned above the part of the re-conveying path P2 defined by the re-conveying chute 13. Further, the re-conveying path P2 as a whole is positioned above the sheet tray 10.

In a case where the drawer 59 supporting the registration roller 35a is attachable to and detachable from the housing 2 and the drawer 59 attached to the housing 2 is made movable frontward relative to the housing 2, positioning accuracy of the drawer 59 attached to the housing 2 relative to the housing 2 may be degraded, compared to a case where the drawer 59 is fixed to the housing 2. Lower positioning accuracy of the drawer 59 relative to the housing 2 may lead to degradation in the sheet-orientation correcting function and the sheet conveying function by the registration roller 35a.

However, in the present embodiment, the re-conveying path P2 is positioned above the sheet tray 10, and the part of the re-conveying path P2 defined by the re-conveying chute 13 is positioned between the sheet tray 10 and the drawer 59 in the up-down direction. As such, this configuration according to the embodiment can shorten an entire length of the re-conveying path P2, if compared to a structure where a part of the re-conveying path P2 is arranged below the sheet tray 10. Accordingly, the sheet-orientation correcting function of the registration roller 35a can be maintained with respect to the sheet S conveyed along the re-conveying path P2. Further, since a distance from the registration roller 35a to the first re-conveying roller pair 36 of the re-conveying path P2 can be made shorter, the sheet conveying function by the registration roller 35a is also less likely to be degraded.

Further, in the image-forming apparatus 1 according to the embodiment, while an image is being formed by the image forming unit 5 on one side of a first sheet S supplied from the sheet tray 10, a second sheet S (an image was already formed on one side thereof) can be retained at the re-conveying path P2; and an image can be formed on the other side of the second sheet S immediately after the image formation on the one side of the first sheet S is complete.

In performing continuous printing on a plurality of sheets S by way of keeping the sheets S held on the re-conveying path P2 in this way, positioning of a portion of the re-conveying path P2 between the sheet tray 10 and the drawer 59 can make the entire length of the re-conveying path P2 shorter, thereby enabling the continuous printing to be performed at a higher speed.

Further, since the drawer 59 is positioned above the part of the re-conveying path P2 defined by the re-conveying chute 13, mechanical interference between the drawer 59 and the re-conveying chute 13 does not occur when the drawer 59 is pulled out of the housing 2 through the front opening 2F.

Incidentally, the drawer 59 of the depicted embodiment includes the registration roller 35. However, the drawer 59 may not include the registration roller 35a, but the registration roller 35a may be supported by a component other than the drawer 59 in the housing 2. In this modified configuration as well, the drawer 59 can be so configured that the drawer 59 can be pulled out of the housing 2 through the front opening 2F without any interference with the re-conveying chute 13.

### [Moving Directions of the Re-Conveying Chute 13]

The re-conveying chute 13 is attachable to and detachable from the housing 2. The rear surface 2B of the housing 2 has a second rear opening 2Rb. The second rear opening 2Rb is positioned below the first rear opening 2Ra. The second rear opening 2Rb is an example of “second opening of the second side wall” of the disclosure.

In the present embodiment, the first rear opening 2Ra and the second rear opening 2Rb constitute in combination a single opening that is open on the rear surface 2B of the housing 2. However, the first rear opening 2Ra and the second rear opening 2Rb may be separated from each other by a frame, for example, so that the first rear opening 2Ra and the second rear opening 2Rb are provided as two distinctive openings.

The re-conveying chute 13 attached to the housing 2 is movable, through the second rear opening 2Rb, in a direction from the front surface 2A toward the rear surface 2B. That is, the re-conveying chute 13 attached to the housing 2 is movable rearward through the second rear opening 2Rb.

The re-conveying chute 13 can be withdrawn and detached from the housing 2 by moving the re-conveying chute 13 attached to the housing 2 rearward. As illustrated in FIG. 5, the re-conveying chute 13 attached to the housing 2 can be pulled out of the housing 2 rearward through the second rear opening 2Rb when the rear cover 23 is at the closed position.

As described above, in the image-forming apparatus 1, the drawer 59 can be detached from the housing 2 by pulling out the drawer 59 frontward, whereas the re-conveying chute 13 can be detached from the housing 2 by pulling out the re-conveying chute 13 rearward.

Since the re-conveying chute 13 and the drawer 59 can be pulled out of the housing 2 respectively in opposite directions from each other, pulling out of the re-conveying chute 13 from the housing 2 can be performed without any interference with the pulling out of the drawer 59 from the housing 2. Likewise, the pulling out of the drawer 59 from the housing 2 can be performed without any interference with the pulling out of the re-conveying chute 13 from the housing 2.

Further, the re-conveying chute 13 can be moved frontward through the second rear opening 2Rb without any interference with the drawer 59 for attachment of the re-conveying chute 13 to the housing 2. Similarly, the drawer 59 can be moved rearward through the front opening 2F without any interference with the re-conveying chute 13 for attachment of the drawer 59 to the housing 2.

### [Moving Directions of the Fixing Device 60]

As illustrated in FIGS. 2 and 6, the fixing device 60 is exposed to an outside of the housing 2 through the first rear opening 2Ra when the rear cover 23 is at the open position. The fixing device 60 is attachable to and detachable from the housing 2 through the first rear opening 2Ra when the rear cover 23 is at the open position.

The fixing device 60 attached to the housing 2 is movable, through the first rear opening 2Ra, in the direction from the front surface 2A toward the rear surface 2B. That is, the fixing device 60 attached to the housing 2 is movable rearward through the first rear opening 2Ra.

The fixing device 60 can be pulled out of the housing 2 and detached therefrom through the first rear opening 2Ra by moving the fixing device 60 attached to the housing 2 rearward when the rear cover 23 is at the open position.

As described above, in the image-forming apparatus 1, the drawer 59 can be detached from the housing 2 by pulling out the drawer 59 frontward, whereas the fixing device 60 can be detached from the housing 2 by pulling out the fixing device 60 rearward.

In this way, since the direction in which the fixing device 60 is pulled out from the housing 2 is opposite the direction in which the drawer 59 is pulled out from the housing 2, the fixing device 60 can be smoothly pulled out of the housing 2 without any interference with the pulling out of the drawer 59 from the housing 2. Likewise, the drawer 59 can be smoothly pulled out of the housing 2 without any interference with the pulling out of the fixing device 60 from the housing 2.

Further, for attachment of the fixing device 60 to the housing 2, the fixing device 60 can be moved frontward through the first rear opening 2Ra without any interference with the drawer 59. Similarly, for attachment of the drawer 59 to the housing 2, the drawer 59 can be moved rearward through the front opening 2F without any interference with the fixing device 60.

### [Positional Relationship Between Drawer 59 and Fixing Device 60]

As illustrated in FIG. 1, the drawer 59 and the fixing device 60 are arranged in the housing 2 such that at least a part of the drawer 59 and at least a part of the fixing device 60 are overlapped with each other in the up-down direction. That is, the part of the drawer 59 and the part of the fixing device 60 are positioned at the same height as each other in the up-down direction, and the drawer 59 and the fixing device 60 are overlapped with each other as viewed in a horizontal direction perpendicular to the up-down direction (in the present embodiment, as viewed in the front-rear direction).

With this structure, the drawer 59 and the fixing device 60 can occupy a smaller space inside the housing 2 in the up-down direction, and the housing 2 can be made compact in the up-down direction.

### [Relationship Between Rear Cover 23 and Locus of Fixing Device 60]

As illustrated in FIGS. 2 and 6, the fixing device 60 can be attached to and detached from the housing 2 by moving the fixing device 60 in the front-rear direction relative to the housing 2 when the rear cover 23 is at the open position. At this time, while being at the opening position, the rear cover 23 is positioned offset from a locus of the fixing device 60 that is defined by movement of the fixing device 60 in the front-rear direction so as not to interfere with the fixing device 60.

With this configuration, in the process of moving the fixing device 60 in the front-rear direction for attachment/detachment of the fixing device 60 to and from the housing 2, both the pulling out of the fixing device 60 from the housing 2 and attachment of the fixing device 60 to the housing 2 can be performed smoothly without being disturbed by the rear cover 23.

### [Relationship Between Rear Cover 23 and Handle of Fixing Device 60]

As illustrated in FIGS. 1 and 6, the rear cover 23 includes a plurality of ribs 231. Each rib 231 protrudes frontward from an inner surface 23A of the rear cover 23 when the rear cover 23 is at the closed position. The inner surface 23A of the rear cover 23 faces the fixing device 60 when the rear cover 23 is at the closed position.

In a state where the rear cover 23 is at the closed position, each rib 231 extends in the up-down direction. That is, each rib 231 extends, on the inner surface 23A, from a position adjacent to the pivot shaft 23a toward a free end of the rear cover 23. Further, the plurality of ribs 231 is arrayed with each other in the left-right direction at intervals.

The ribs 231 form the conveying path P1 when the rear cover 23 is at the closed position, and are configured to guide the sheet S conveyed from the fixing device 60 toward the discharge tray 22. Each of the two neighboring ribs 231 define therebetween an air flow passage FP to allow circulation of air therethrough when the rear cover 23 is at the closed position.

As illustrated in FIGS. 1 and 5, a fan 7 is provided in the housing 2 to discharge air inside the housing 2 to the outside of the housing 2. By driving the fan 7 while the rear cover 23 is at the closed position, the air flows upward through the air flow passages FP inside the housing 2. That is, the rear cover 23 forms the air flow passages FP when the rear cover 23 is at the closed position.

As illustrated in FIGS. 1, 7, and 8, the fixing device 60 includes a fixing-device cover 63 that covers the heat roller 61 and the pressure roller 62, and a pair of handles 64 for moving the fixing device 60. Each handle 64 protrudes rearward from a corresponding end portion of the fixing-device cover 63 in the left-right direction. The handles 64 are configured to be gripped by a user. The user grips the respective handles 64 and pulls the same rearward in order to move the fixing device 60 attached to the housing 2 rearward.

As illustrated in FIG. 1, a rear end of each handle 64 is positioned rearward relative to a front end of each rib 231 when the rear cover 23 is at the closed position. Hence, the handles 64 of the fixing device 60 and the ribs 231 of the rear cover 23 are overlapped with each other as viewed in the left-right direction. Further, the handles 64 of the fixing device 60 and the air flow passages FP of the rear cover 23 are overlapped with each other as viewed in the left-right direction.

Since the handle 64 and the air flow passages FP are arranged to overlap with each other as viewed in the left-right direction, the housing 2 can be made compact in the front-rear direction, compared to a structure where the handles 64 and the air flow passages FP are arranged offset from each other in the front-rear direction which is coincident with the moving direction of the fixing device 60.

### [Positional Relationship Among Gears in Fixing Device 60]

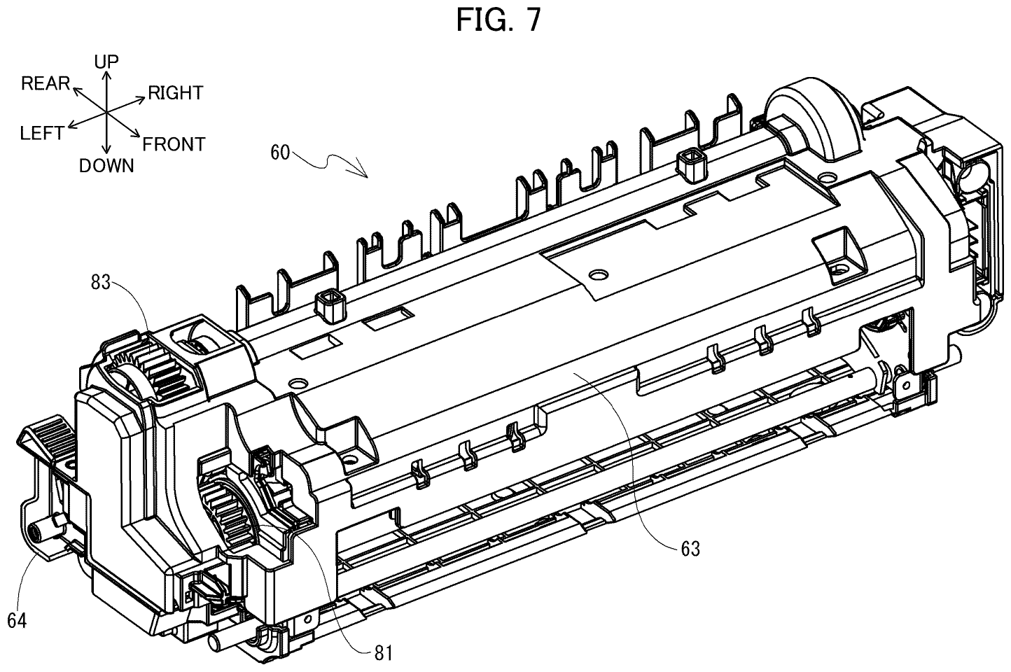

As illustrated in FIGS. 7 through 9, the fixing device 60 includes a fixing-device drive gear 81, a discharge-roller drive gear 82, and a fixing-device separation gear 83. The fixing-device drive gear 81, the discharge-roller drive gear 82, and the fixing-device separation gear 83 are at a left end portion of the fixing device 60.

The fixing-device drive gear 81 is a gear configured to drive the heat roller 61. The fixing-device drive gear 81 is rotatable integrally with the heat roller 61. The discharge-roller drive gear 82 is a gear configured to drive the fixing-device discharge roller 65a. The discharge-roller drive gear 82 is rotatable integrally with the fixing-device discharge roller 65a. The fixing-device drive gear 81 is an example of “rotatable-heating-body drive gear” of the disclosure. The discharge-roller drive gear 82 is an example of “discharge-roller drive gear” of the disclosure.

The fixing device 60 is switchable in state between a pressure contacting state where the heat roller 61 and the pressure roller 62 are in pressure contact with each other and a separated state where the heat roller 61 and the pressure roller 62 are separated from each other. The fixing-device separation gear 83 is a gear configured to move the pressure roller 62 away from the heat roller 61 to switch the fixing device 60 in state from the pressure contacting state to the separated state. The fixing-device separation gear 83 is an example of “separation gear” of the disclosure.

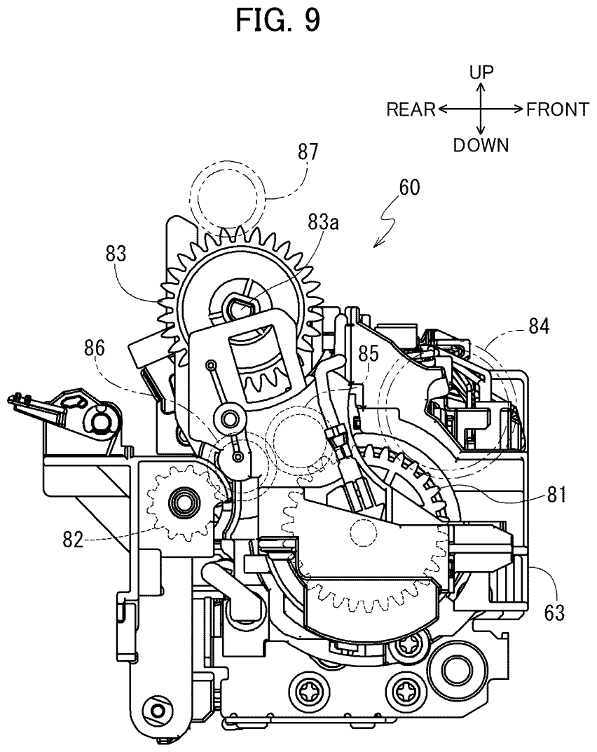

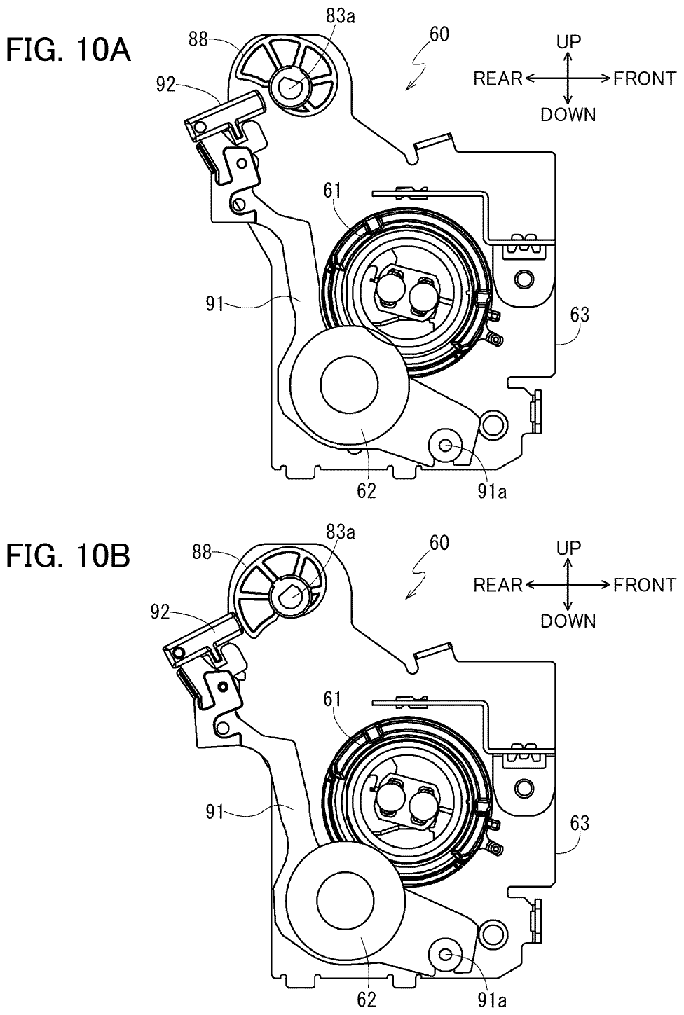

As illustrated in FIGS. 9 through 10B, the fixing-device separation gear 83 is fixed to a gear shaft 83a. Further, a pair of separation cams 88 is fixed to the shaft 83a. The fixing-device separation gear 83 and the separation cams 88 are integrally rotatable.

The fixing device 60 includes a pair of pivot arms 91 supporting the pressure roller 62. Each pivot arm 91 has one end portion supported by the fixing-device cover 63 through a corresponding pivot shaft 91a so as to be pivotally movable about the corresponding pivot shaft 91a. Each pivot arm 91 has another end portion provided with an abutment part 92 configured to abut on the corresponding separation cam 88. That is, with respect to each pivot arm 91, the abutment part 92 is positioned opposite the pivot shaft 91a with respect to the pressure roller 62.

The fixing device 60 is switchable in state between the pressure contacting state (where the pressure roller 62 is in pressure contact with the heat roller 61) and the separated state (where the pressure roller 62 is separated away from the heat roller 61) by the pivotal movement of each pivot arm 91 about the corresponding pivot shaft 91a. The pressure roller 62 is normally urged toward the heat roller 61 by an urging member (not illustrated) to contact the heat roller 61.

While the fixing device 60 is in the pressure contacting state as illustrated in FIG. 10A, the separation cam 88 is at a separated position where each separation cam 88 is separated from the abutment part 92 of the corresponding pivot arm 91. As the fixing-device separation gear 83 rotates from this state depicted in FIG. 10A, the separation cams 88 are also rotated following the rotation of the fixing-device separation gear 83, thereby being brought into abutment with the abutment parts 92 of the respective pivot arms 91, as illustrated in FIG. 10B.

Each separation cam 88 in abutment with the abutment part 92 of the corresponding pivot arm 91 urges the pivot arm 91 to pivot about the corresponding pivot shaft 91a in such a direction that the pressure roller 62 is moved away from the heat roller 61. The pressure roller 62 is thus separated from the heat roller 61.

On the other hand, as the fixing-device separation gear 83 is driven to rotate the separation cams 88 following the rotation of the fixing-device separation gear 83 while the fixing device 60 is in the separated state, each separation cam 88 becomes separated from the abutment part 92 of the corresponding pivot arm 91. Upon separation of the separation cams 88 from the corresponding abutment parts 92, the pressure roller 62 is urged to move toward the heat roller 61 by the urging force of the non-illustrated urging member, thereby bringing the pressure roller 62 into pressure contact with the heat roller 61. The fixing device 60 is thus switched to the pressure contacting state from the separated state.

As illustrated in FIG. 9, the fixing device 60 also includes an input gear 84 in meshing engagement with the fixing-device drive gear 81. The input gear 84 is a gear configured to input a driving force from a drive source (not illustrated) into the fixing-device drive gear 81.

The fixing device 60 further includes a first intermediate gear 85 in meshing engagement with the fixing-device drive gear 81, and a second intermediate gear 86 in meshing engagement with the first intermediate gear 85 and the discharge-roller drive gear 82.

Upon receipt of the driving force from the input gear 84, the fixing-device drive gear 81 rotates, thereby rotating the heat roller 61. Further, the driving force inputted into the fixing-device drive gear 81 is also transmitted to the discharge-roller drive gear 82 through the first intermediate gear 85 and the second intermediate gear 86. Upon receipt of the driving force, the discharge-roller drive gear 82 rotates, thereby rotating the fixing-device discharge roller 65a.

In this way, the heat roller 61 and the fixing-device discharge roller 65a are both configured to be driven by the driving force inputted from the input gear 84. The fixing-device drive gear 81, the first intermediate gear 85, the second intermediate gear 86 and the discharge-roller drive gear 82 constitute in combination a gear train for driving the heat roller 61 and the fixing-device discharge roller 65a.

The fixing device 60 further includes an input gear 87 in meshing engagement with the fixing-device separation gear 83. The input gear 87 is a gear configured to input the driving force from the non-illustrated drive source into the fixing-device separation gear 83. The fixing-device separation gear 83 rotates upon receipt of the driving force from the input gear 87, thereby causing the separation cam 88 to rotate together with the fixing-device separation gear 83 to switch the fixing device 60 between the pressure contacting state and the separated state.

The fixing-device drive gear 81, discharge-roller drive gear 82, and fixing-device separation gear 83 are arranged in the up-down direction, specifically, toward the bottom, in the following order: the fixing-device separation gear 83, the discharge-roller drive gear 82, and the fixing-device drive gear 81. That is, the fixing-device drive gear 81 is positioned lower than the discharge-roller drive gear 82, which is positioned lower than the fixing-device separation gear 83.

By arranging the fixing-device separation gear 83, the discharge-roller drive gear 82, and the fixing-device drive gear 81 in this order from the top toward the bottom, the discharge-roller drive gear 82 and the fixing-device drive gear 81 can be positioned closer to each other than by arranging the discharge-roller drive gear 82, the fixing-device separation gear 83, and the fixing-device drive gear 81 in this order from the top toward the bottom. Hence, arranging the discharge-roller drive gear 82 and fixing-device drive gear 81 closer to each other can simplify the gear train for transmitting the driving force from the drive source to the fixing-device drive gear 81 and to the discharge-roller drive gear 82.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. An image-forming apparatus comprising:
a housing comprising:
a first side wall having a first opening; and
a second side wall positioned apart from the first side wall in a first direction;
a sheet supply tray configured to support a sheet thereon and configured to be accommodated in the housing;
an image forming unit comprising a cartridge storing therein a developing agent, the image forming unit being configured to form an image on the sheet supplied from the sheet supply tray with the developing agent;
a drawer configured to support the cartridge, the drawer being movable relative to the housing in the first direction through the first opening, the drawer supporting a registration roller configured to correct an orientation of the sheet;
a re-conveying path along which the sheet is configured to be conveyed toward the image forming unit after an image is formed on one side of the sheet by the image forming unit, the re-conveying path being positioned upward of the sheet supply tray in an up-down direction; and
a re-conveying chute configured to form a part of the re-conveying path, the part of the re-conveying path being positioned between the sheet supply tray and the drawer in the up-down direction.

2. The image-forming apparatus according to claim 1,
wherein the second side wall has a second opening,
wherein the re-conveying chute is attachable to the housing, the re-conveying chute attached to the housing being movable relative to the housing through the second opening in a direction from the first side wall toward the second side wall, and
wherein the drawer is attachable to the housing, the drawer attached to the housing being movable, relative to the housing, through the first opening in a direction from the second side wall toward the first side wall.

3. The image-forming apparatus according to claim 1, further comprising a fixing device attachable to and detachable from the housing, the fixing device including a rotatable heating body and a rotatable pressing body,
wherein the second side wall has an opening, the fixing device attached to the housing being movable relative to the housing through the opening in a direction from the first side wall toward the second side wall, and
wherein the drawer is attachable to the housing, the drawer attached to the housing being movable, relative to the housing, through the first opening in a direction from the second side wall toward the first side wall.

4. The image-forming apparatus according to claim 3,
wherein at least a part of the drawer and at least a part of the fixing device are overlapped with each other in the up-down direction.

5. The image-forming apparatus according to claim 3,
wherein the housing comprises a cover movable, relative to the second side wall, between an open position where the cover opens the opening and a closed position where the cover closes the opening, and
wherein the cover at the open position is positioned offset from a locus of the fixing device which is defined by movement of the fixing device relative to the housing.

6. The image-forming apparatus according to claim 3,
wherein the housing comprises a cover movable, relative to the second side wall, between an open position where the cover opens the opening and a closed position where the cover closes the opening, the cover forming an air flow passage when the cover is at the closed position, and
wherein the fixing device further comprises a handle configured to be gripped by a user for moving the fixing device, the handle and the air flow passage being overlapped with each other as viewed in an axial direction of the rotatable pressing body, the axial direction being perpendicular to the first direction and the up-down direction.

7. The image-forming apparatus according to claim 3,
wherein the fixing device further comprises:
a discharge roller positioned downstream relative to the rotatable heating body and the rotatable pressing body in a sheet conveying direction;
a separation gear configured to separate the rotatable pressing body from the rotatable heating body;
a discharge-roller drive gear configured to drive the discharge roller and positioned lower than the separation gear in the up-down direction; and
a rotatable-heating-body drive gear configured to drive the rotatable heating body and positioned lower than the discharge-roller drive gear in the up-down direction.

8. The image-forming apparatus according to claim 1,
wherein the image forming unit further comprises a photosensitive drum supported on the drawer, and
wherein the cartridge further comprises a developing roller configured to contact the photosensitive drum upon attachment of the cartridge to the drawer.

9. An image-forming apparatus comprising:
a housing comprising:
a first side wall having a first opening; and
a second side wall positioned apart from the first side wall in a first direction;
a sheet supply tray configured to support a sheet and configured to be accommodated in the housing;
an image forming unit comprising a cartridge storing therein a developing agent, the image forming unit being configured to form an image on the sheet supplied from the sheet supply tray with the developing agent;
a drawer configured to support the cartridge, the drawer being movable relative to the housing in the first direction through the first opening;
a re-conveying path along which the sheet is configured to be conveyed toward the image forming unit after an image is formed on one side of the sheet by the image forming unit, the re-conveying path being positioned upward of the sheet supply tray in an up-down direction; and
a re-conveying chute configured to form a part of the re-conveying path, the part of the re-conveying path being positioned between the sheet supply tray and the drawer in the up-down direction.

10. The image-forming apparatus according to claim 9,
wherein the second side wall has a second opening, and
wherein the re-conveying chute is attachable to the housing, the re-conveying chute attached to the housing being movable relative to the housing through the second opening in a direction from the first side wall toward the second side wall, and
wherein the drawer is attachable to the housing, the drawer attached to the housing being movable, relative to the housing, through the first opening in a direction from the second side wall toward the first side wall.

11. The image-forming apparatus according to claim 9, further comprising a fixing device attachable to and detachable from the housing, the fixing device including a rotatable heating body and a rotatable pressing body,
wherein the second side wall has an opening, the fixing device attached to the housing being movable relative to the housing through the opening in a direction from the first side wall toward the second side wall, and
wherein the drawer is attachable to the housing, the drawer attached to the housing being movable, relative to the housing, through the first opening in a direction from the second side wall toward the first side wall.

12. The image-forming apparatus according to claim 11,
wherein at least a part of the drawer and at least a part of the fixing device are overlapped with each other in the up-down direction.

13. The image-forming apparatus according to claim 9, further comprising a conveying roller provided on the drawer and configured to convey the sheet.
